(19) United States
(12) Patent Application Publication
(10) Pub. No.: US 2025/0260160 A1
(43) Pub. Date: Aug. 14, 2025

(54) ANTENNA SYSTEMS

(71) Applicant: Parsec Technologies, Inc., Plano, TX (US)

(72) Inventors: Michael A. Neenan, Plano, TX (US); Richard Loy Smith, JR., Dallas, TX (US); Rauhon Ahmed Shaik, Wylie, TX (US); George Alexander Bednekoff, Plano, TX (US)

(21) Appl. No.: 19/047,432

(22) Filed: Feb. 6, 2025

Related U.S. Application Data
(60) Provisional application No. 63/551,924, filed on Feb. 9, 2024.

(51) Int. Cl. H01Q 1/42; H01Q 1/22; H01Q 1/44; H01Q 21/28

(52) U.S. Cl. CPC H01Q 1/42; H01Q 1/2291; H01Q 1/44; H01Q 21/28

(57) ABSTRACT

A device may include a radome. A device may include a spacer coupled to the radome. A device may include a first antenna element formed on a first printed circuit board (PCB) and configured to be housed by the radome, wherein the first antenna element is a multi-band antenna element comprising: one or more low-band radiating elements, one or more mid-band radiating elements; and one or more high-band radiating elements. A device may include a second antenna element formed on a second PCB and configured to be housed by the radome, the second antenna element comprising one or more WiFi antenna elements. A device may include a third antenna element formed on a third PCB and configured to be housed by the radome, the third antenna element comprising one or more global positioning system (GPS) antenna elements.

### INCORPORATION BY REFERENCE TO ANY PRIORITY APPLICATIONS

The present application claims priority benefit to U.S. Provisional Application No. 63/551,924 filed Feb. 9, 2024, entitled “ANTENNA SYSTEMS,” which is hereby incorporated by reference herein in its entirety. Any and all applications for which a foreign or domestic priority claim is identified in the Application Data Sheet as filed with the present application are hereby incorporated by reference under 37 CFR 1.57 and made a part of this specification.

### BACKGROUND

### Field

Models representing data relationships and patterns, such as functions, algorithms, systems, and the like, may accept input (sometimes referred to as an input vector), and produce output (sometimes referred to as an output vector) that corresponds to the input in some way. For example, a machine learning model may be implemented as an artificial neural network. Artificial neural networks are artificial in the sense that they are computational entities, analogous to biological neural networks, but implemented by computing devices. Output of neural-network-based models, typically in the form of a score, is obtained by doing a “forward pass.” The forward pass involves multiplying large neural network weight matrices, representing the parameters of the model, by vectors corresponding to input vectors or hidden intermediate representations, as well as performing other mathematical operations. The parameters of a neural network can be set in a process referred to as training.

The present disclosure relates to the field of wireless communication, and more particularly to antenna systems and antennas that cover multiple frequency bands used in the telecommunication wireless spectrum.

### DESCRIPTION OF THE RELATED ART

Over the last few decades, 3GPP as a collaborative organization has developed protocols for mobile telecommunications. The latest operational standard is known as 5G. Wireless communication relies on a variety of radio components including radio antennas that are used for transmitting and receiving information via electromagnetic waves. To communicate to specific devices without interference from other devices, radio transceivers and receivers communicate within a dedicated frequency bandwidth and have associated antennas that are configured to electromagnetically resonate at frequencies within the dedicated bandwidth. As more wireless devices are used on a frequency bandwidth, a communication bottleneck occurs as wireless devices compete for frequency channels within a dedicated bandwidth. 3GPP frequency bands range from 450 MHz to 8 GHz and beyond, however, antennas configured to resonate within this spectrum only resonate below 8 GHz for mobile 3GPP telecommunication standards. To capture a greater portion of the 3GPP or other telecommunication spectrum, either an antenna array of various antenna configurations is used, or a single geometrically complex antenna can be used. An antenna array, in most instances, takes up too much space and is therefore impractical for small devices, but employing a single antenna will have a useable bandwidth that is limited by its geometrical configuration. In one example, a known antenna configuration permits a 700 MHz-2.7 GHz frequency band; however, a single antenna configuration that permits a wider frequency band is desired. Additionally, it can be difficult and expensive to manufacture, assemble, and procure materials for components of antenna array systems. This may result in a system with poor functionality and/or coverage.

### SUMMARY

This disclosure relates to antennas that cover multiple frequency bands that are prolific in today's telecommunication wireless spectrum. The advances in telecommunications and wireless devices have expanded the number of frequency bands that a radio can support for desirable coverage. For example, there are over 30 fifth generation (5G) bands that a radio may be asked to support if the radio is to provide ubiquitous coverage for a mobile device. Even as the LTE bands overlap one another, there are numerous gaps between the bands to exploit. A multi-band approach to the antenna's frequency response provides a unique and novel radiating structure to support the numerous 5G bands.

According to some implementations, the techniques described herein relate to an antenna assembly, including: a radome; a spacer coupled to the radome; a first antenna element formed on a first printed circuit board (PCB) and configured to be housed by the radome, wherein the first antenna element is a multi-band antenna element including: one or more low-band radiating elements; one or more mid-band radiating elements; and one or more high-band radiating elements; a second antenna element formed on a second PCB and configured to be housed by the radome, the second antenna element including one or more WiFi antenna elements; and a third antenna element formed on a third PCB and configured to be housed by the radome, the third antenna element including one or more global positioning system (GPS) antenna elements.

According to some implementations, the techniques described herein relate to a multi-band antenna element formed on a printed circuit board (PCB), the multi-band antenna element including: one or more low-band radiating elements; one or more mid-band radiating elements; and one or more high-band radiating elements, wherein the one or more low-band radiating elements includes a cutout section, wherein the cutout section is configured to provide a discontinuity in a current flow at frequencies above a threshold.

According to some implementations, the techniques described herein relate to an antenna assembly including: a radome; a spacer configured to be coupled to the radome; a base housed within the radome, wherein the base is circular in shape; a first antenna element formed on a first printed circuit board (PCB) and configured to be housed by the radome, wherein the first antenna element is a multi-band antenna element including: one or more low-band radiating elements; one or more mid-band radiating elements; and one or more high-band radiating elements; a second antenna element formed on a second PCB and configured to be housed by the radome, the second antenna element including one or more WiFi antenna elements; and a third antenna element formed on a third PCB and configured to be housed by the radome, the third antenna element including one or more global positioning system (GPS) antenna elements, wherein the first antenna element and the second antenna element are coupled to the base and arranged along a circumference of the base.

According to some implementations, the techniques described herein relate to an antenna assembly, including: a radome; a spacer coupled to the radome; four first antenna elements, each formed on a separate first printed circuit board (PCB) and each configured to be housed by the radome, wherein each of the four first antenna elements are multi-band antenna elements, each of the four first antenna elements including: one or more low-band radiating elements, configured for low band radiation; one or more mid-band radiating elements, configured for mid band radiation; and one or more high-band radiating elements, configured for high band radiation; four second antenna elements, each formed on a separate second PCB and each configured to be housed by the radome, the four second antenna elements each including one or more WiFi antenna elements; a third antenna element formed on a third PCB and configured to be housed by the radome, the third antenna element including one or more global positioning system (GPS) antenna elements; and a base, coupled to the four first antenna elements and the four second antenna elements, wherein the four first antenna elements and the four second antenna elements are arranged along a circumference of the base in an alternating pattern, wherein the alternating pattern includes alternating positions of the four second antenna elements and the four first antenna elements.

Some advantageous features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one implementation of the present disclosure in detail, it is to be understood that the implementations are not limited in its application to the details of construction and the arrangements of the components set forth in the following description or illustrated in the drawings. The implementations are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. Accordingly, the claims should be regarded as including such equivalent constructions in so far as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIGS. 1A-1F illustrate various views of an example antenna assembly, in accordance with some aspects of this disclosure.

FIG. 2 illustrates a perspective view of the example antenna assembly of FIGS. 1A-1F, in accordance with some aspects of this disclosure.

FIGS. 3A-3F illustrate various views of one or more example antenna elements, in accordance with some aspects of this disclosure.

FIGS. 4A-4B illustrate various views of one or more example antenna elements, in accordance with some aspects of this disclosure.

FIGS. 5A-5C illustrate various views of an example coaxial assembly for an antenna assembly, in accordance with some aspects of this disclosure.

FIGS. 6A-6B illustrate various views of an example support assembly, in accordance with some aspects of this disclosure.

FIGS. 7A-7C illustrate various views of an example support assembly and one or more corresponding components, in accordance with some aspects of this disclosure.

FIG. 8 illustrates a view of an example support assembly, in accordance with some aspects of this disclosure.

While the implementations and method of the present application is susceptible to various modifications and alternative forms, specific implementations thereof have been shown by way of example in the drawings and are herein described in detail. It should be understood, however, that the description herein of specific implementations is not intended to limit the application to the particular implementation disclosed, but on the contrary, the intention is to cover all modifications, equivalents, and alternatives falling within the spirit and scope of the process of the present application as defined by the appended claims.

### DETAILED DESCRIPTION

Illustrative implementations of the present disclosure are described below. In the interest of clarity, not all features of an actual implementation are described in this specification. It will of course be appreciated that in the development of any such actual implementation, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the implementations described herein may be oriented in any desired direction.

The system and method will be understood, both as to its structure and operation, from the accompanying drawings, taken in conjunction with the accompanying description. Several implementations of the system may be presented herein. It should be understood that various components, parts, and features of the different implementations may be combined together and/or interchanged with one another, all of which are within the scope of the present application, even though not all variations and particular implementations are shown in the drawings. It should also be understood that the mixing and matching of features, elements, and/or functions between various implementations is expressly contemplated herein so that one of ordinary skill in the art would appreciate from this disclosure that the features, elements, and/or functions of one implementation may be incorporated into another implementation as appropriate, unless otherwise described. As used herein, “system” and “assembly” are used interchangeably. It should be noted that the articles “a”, “an”, and “the”, as used in this specification, include plural referents unless the content clearly dictates otherwise. Dimensions provided herein provide for an exemplary implementation, however, alternate implementations having scaled and proportional dimensions of the presented exemplary implementation are also considered. Additional features and functions are illustrated and discussed below.

According to some implementations, features, and aspects of this disclosure, an antenna assembly is disclosed. The antenna assembly can include a radome, a spacer, and a first antenna element, a second antenna element, and a third antenna element. The first antenna element can be formed on a first printed circuit board (PCB) and configured to be housed by the radome, wherein the first antenna element is a multi-band antenna element can comprise one or more low-band radiating elements; one or more mid-band radiating elements; and one or more high-band radiating elements. The second antenna element can be formed on a second PCB and configured to be housed by the radome, the second antenna element comprising one or more WiFi antenna elements. The third antenna element can be formed on a third PCB and configured to be housed by the radome, the third antenna element comprising one or more global positioning system (GPS) antenna elements.

The following detailed description of certain implementations presents various descriptions of specific implementations. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain implementations can include more elements than illustrated in a drawing and/or a subset of the elements illustrated in a drawing. Further, some implementations can incorporate any suitable combination of features from two or more drawings.

Objects that are coupled together can be permanently connected together or releasably connected together. Objects that are permanently connected together can be formed out of one sheet of material or multiple sheets of material. The type of connection can provide different means for the realization of particular advantages and/or convenience consistent with the suitable function and performance of the device.

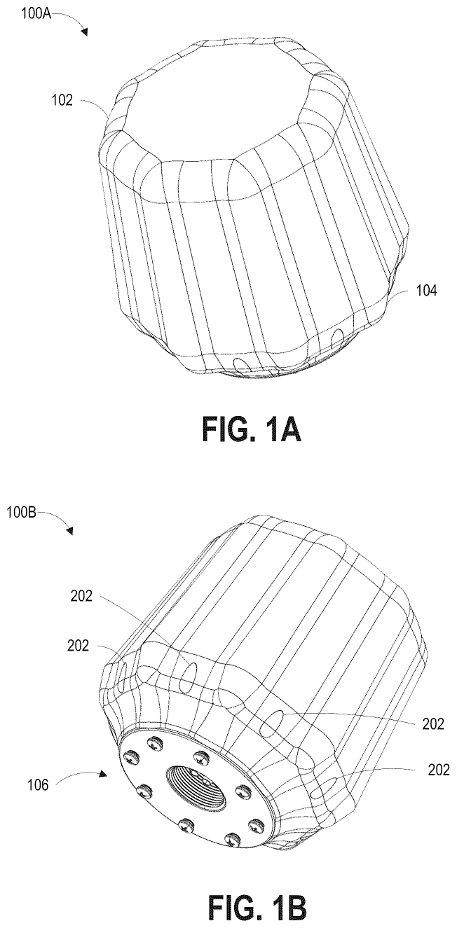

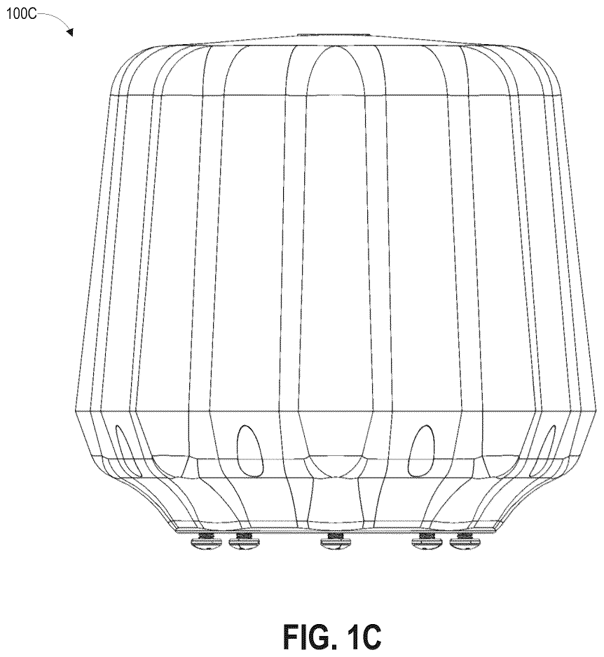

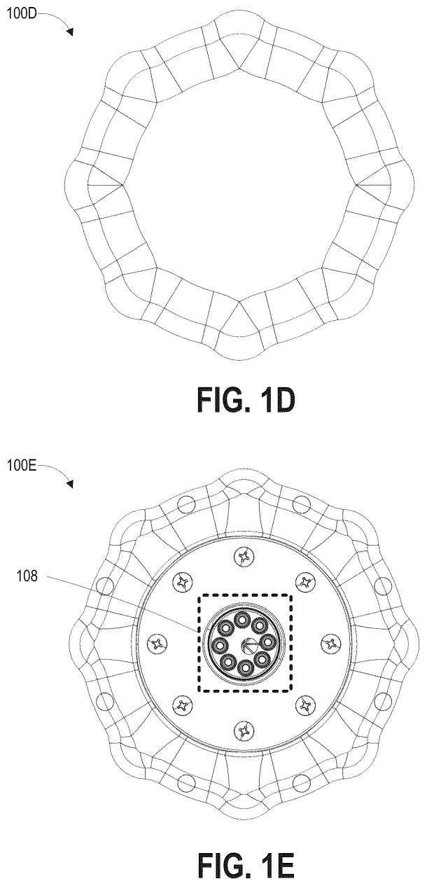

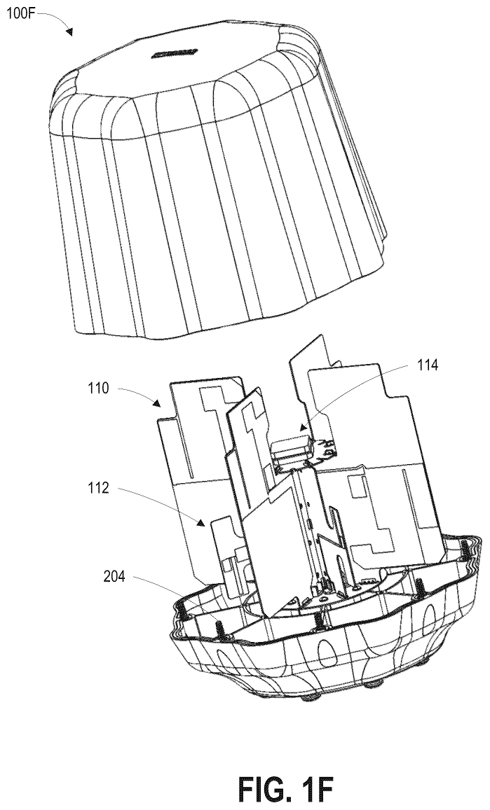

FIGS. 1A-1F illustrate various views of an example antenna assembly. As illustrated in FIGS. 1A-1B, a perspective front side view 100A and rear side view 100B, respectively, of an antenna assembly 100 in accordance with an implementation of the present disclosure. FIGS. 1C-1E illustrate side view 100C, top view 100D, and bottom view 100E of the antenna assembly 100, respectively. FIG. 1F illustrates a perspective exploded front view 100F. The antenna assembly 100 may include a radome 102, a spacer 104, a support assembly 106, coaxial cable assembly 108, a first antenna 110, a second antenna 112, and a third antenna 114. The antenna assembly 100 may be configured to provide wireless cellular and internet connectivity for a plurality of uses (e.g., data, voice communication, video, and/or the like). The radome 102 can be configured to provide housing for the first antenna 110, the second antenna 112, the third antenna 114, and the coaxial cable assembly 108. For example, the radome 102 can be configured to house the first antenna 110, the second antenna 112, the third antenna 114 such that the radome 102 does not interfere with any radiating electromagnetic signals radiating from the first antenna 110, the second antenna 112, or the third antenna 114.

According to some implementations, the antenna assembly 100 can include one or more first antennas (e.g., four of the first antenna 110) and one or more second antennas (e.g. four of the second antenna 112). In some cases, the first antennas can be multi-band cellular antennas and the second antennas can be Wi-Fi antennas. The first antennas can be positioned such that each of the first antennas is positioned approximately orthogonal from one or more of the other first antennas. For example, according to some implementations, one or more of the first antennas is positioned 90-degrees from one or more of the other first antennas (e.g., 90-degrees, 180-degrees, 270-degrees). In this manner, the first antennas may be positioned such that the radiation patterns are similar in polarization. In other embodiments, the antenna assembly 100 can include any number of first antennas. For example, the antenna assembly 100 can include fewer than, or greater than, four first antennas. In some examples, the first antennas can be oriented in a variety of configurations. For example, the first antennas can be oriented such that radiating elements of at least some of the first antennas face another of the first antennas. In some examples, at least some of the first antennas can be oriented such that radiating elements face away from another of the first antennas. In some examples, the first antennas can be configured such that some of the first antennas face towards each other and others face away from the other first antennas.

The four second antennas can be positioned such that each of the second antennas is positioned approximately orthogonal from one or more of the other second antennas. For example, according to some implementations, one or more of the second antennas is positioned 90-degrees from one or more of the other second antennas (e.g., 90-degrees, 180-degrees, 270-degrees). In this manner, the second antennas are positioned such that the radiation patterns are similar in polarization. In other embodiments, the antenna assembly 100 can include any number of second antennas. For example, the antenna assembly 100 can include fewer than, or greater than, four second antennas. In some examples, the second antennas can be oriented in a variety of configurations. For example, the second antennas can be oriented such that radiating elements of at least some of the second antennas face another of the second antennas. In some examples, at least some of the second antennas can be oriented such that radiating elements face away from another of the second antennas. In some examples, the second antennas can be configured such that some of the second antennas face towards each other and others face away from the other second antennas.

The orientation and the arrangement of the first antennas relative to each other can be selected to optimize the performance of the antenna assembly 100 for the particular use case. In the illustrated example, four of the first antenna 110 are positioned between four of the second antenna 112. The relationship between the first antenna 110 and the second antenna 112 can impact the performance of the antenna assembly 100. Additionally, the relationship between each of the first antennas can impact the performance of the antenna assembly 100. In the illustrated example, four of the first antenna 110 can be positioned in different orientations and extend in a different directions. For example, four of the first antenna 110 can be positioned 90-degrees offset from each other (e.g., 0-degrees, 90-degrees, 180-degrees, and 270-degrees). In this arrangement, one of the first antennas extend in each direction, 90 degrees offset from at least two other first antennas. Further, the first antenna can be configured to face the second antenna. Each of the first antennas can face in one of the four rotational directions, 90-degrees offset from each other.

Similarly, the orientation and the arrangement of the second antennas relative to each other can be selected to optimize the performance of the antenna assembly 100 for the particular use case. In the illustrated example, four of the second antenna 112 are positioned between four of the first antenna 110. The relationship between the second antenna 112 and the first antenna 110 can impact the performance of the antenna assembly 100. Additionally, the relationship between each of the second antennas can impact the performance of the antenna assembly 100. In the illustrated example, four of the second antenna 112 can be positioned in different orientations and extend in a different directions. For example, four of the second antenna 112 can be positioned 90-degrees offset from each other (e.g., 0-degrees, 90-degrees, 180-degrees, and 270-degrees). In this arrangement, one of the second antennas extend in each direction, 90 degrees offset from at least two other second antennas. Further, the second antenna can be configured to face the first antenna. Each of the second antennas can face in one of the four rotational-directions, 90-degrees offset from each other.

In some examples, the radome 102 can be constructed of material that does not interfere with the electromagnetic signals of the first antenna 110, the second antenna 112, the third antenna 114. For example, the properties of the radome materials can include fabrication which may involve curing; electrical properties like the dielectric constant and loss tangent; mechanical properties like Young's modulus; thermal properties like thermal shock and temperature; porosity and rain erosion resistance. In some examples, the radome can be constructed of materials such as plastic, thermoplastic, polycarbonate, acrylonitrile butadiene styrene (ABS), polytetrafluoroethylene (PTFE), glass epoxy (e.g., G10/FR-4), high-performance polyaryletherketones, fluoropolymers, polyimide, polycarbonate (PC) and acrylonitrile butadiene styrene (ABS), acrylonitrile styrene acrylate (ASA), or any other material applicable for purposes disclosed herein.

The radome 102 can be shaped such that the appearance can resemble another product. In some examples, the radome can be configured to function as one or more of the products described herein. For example, the radome can resemble a lighting fixture. In some examples, the radome can include lighting elements coupled to the antenna assembly. The lighting elements can be coupled to any of the components of the antenna assembly. In some examples, the lighting elements can include a detached member independent from the radome, spacer, and support. In some examples, the radome can include light emitting diodes (LEDs). In this manner, the radome can provide illumination to the surrounding area. In some examples, the radome can include at least one solar panel coupled to the antenna assembly. The solar panel can be coupled to any of the components of the antenna assembly. In some examples, the solar panel can include a detached member independent from the radome, spacer, and support. In some examples, the radome can include hardware to mechanically support the solar panel installation on the radome. In some examples, the solar panels can be stationed away from the radome, with electrical connections routed from the solar panels to the radome. The solar panels can be configured to provide power to the antenna assembly 100. For example, the solar panels can be configured to power the lighting elements. In some examples, the antenna assembly 100 can include a touchscreen display. The touchscreen display can be used to illustrate to a user the network capabilities of the antenna assembly 100. For example, the touchscreen display can include hardware and software capable of visually depicting signal strength to the user.

The radome 102 can include a number of fasteners to couple the radome with the spacer 104. The radome 102 can be machined to include prefabricated holes for the fasteners to insert. The spacer can be coupled to the bottom of the radome 102. The spacer 104 has a primary responsibility to separate the radome 102 from the support assembly 106. The spacer can be made of material that does not interfere with the electromagnetic signals of the first antenna 110, the second antenna 112, the third antenna 114. For example, the spacer can include material such as plastic. The spacer can be printed in a three-dimensional (3D) printer, such that the spacer can take any shape or form. The spacer 104 can include prefabricated holes such that the fasteners can perform fastening functions through the holes. The spacer can be coupled to the support assembly 106. The spacer 104 can be coupled to the support using hardware to mount the spacer 104 to the support assembly 106. In some examples, the spacer can be used to mount the antenna system directly onto a structure. For example, the spacer can be used to mount the antenna system on a roof of a building and/or other structures. The spacer can have lighting fixtures coupled to the bottom of the spacer. The lighting fixtures can provide light.

The support assembly 106 can include a structure for mounting the spacer 104 and the radome 102. The support assembly 106 can include a component that is able to support the weight of the radome 102, the spacer 104, the first antenna 110, the second antenna 112, the third antenna 114, and any other hardware to mount to the antenna assembly 100. The support assembly 106 can include a metal mounting plate for affixing the antenna assembly 100, for example, to a mast mount on a ship, a pole-mount support such that the spacer 104 and radome 102 sit atop the pole, or any other mounting support structure applicable to the antenna assembly.

The coaxial cable assembly 108 can include coaxial cables to supply electrical signals to one or more of the first antenna 110, the second antenna 112, and/or the third antenna 114. The coaxial cables can include hard line coaxial cable, flexible coaxial cable, semi-rigid coaxial cable, formable coaxial cable, rigid coaxial cable, twin axial cable, triaxial cable. In some examples, each of the coaxial cables can include a connector. The connectors can include BNC, TNC, SMA, 3.5 mm, 2.92 mm/K Type, N Type, C Type, 7-16 DIN, EIA series. The coaxial cable assembly 108 can be fed through the support assembly 106 such that the coaxial cables are out of sight to a user.

The first antenna 110 can include a multi-band antenna. The first antenna 110 can include a printed circuit board (PCB) having metal elements along the PCB. The metal elements can include radiating elements that propagate electromagnetic signals for radio frequency (RF) communications. The first antenna 110 can include two halves. The first half can include a low band antenna a mid-band antenna and a high band antenna. The low band antenna can include a first arm and a second arm. The first arm and the second arm can be joined to form an L-shape. The low band antenna portion can include a cutout section. The cutout section can include a rectangular shape. The cutout section can be positioned at a location of the joining of the first portion and the second portion. The cutout section can be configured to allow for a discontinuity in a current flow at frequencies above a threshold. The cutout section can be configured to allow for the low-band antenna element to produce a usable a radiation pattern shape at higher bands. The cutout section can be configured to match an impedance for the low-band antenna element. The mid-band antenna can include mid-band radiating element. The mid-band antenna can include a rectangular portion. The high band antenna can include a rectangular portion. The first half can include a transmission line groundplane. The second half can include a low band antenna a mid-band antenna and a high band antenna as disclosed herein. The second half can include a transmission line.

The antenna assembly 100 can include at least one first antenna. According to some implementations, the antenna assembly 100 can include four first antennas. The four first antennas can be positioned such that each of the first antennas is positioned approximately orthogonal from one or more of the other first antennas. For example, according to some implementations, one or more of the first antennas is positioned 90-degrees from one or more of the other first antennas (e.g., 90-degrees, 180-degrees, 270-degrees). In this manner, the first antennas are positioned such that the radiation patterns are similar in polarization.

The second antenna 112 can include a WiFi antenna. The second antenna can include a transmission line and at least one dipole antenna. The antenna assembly 100 can include at least one second antenna. According to some implementations, the antenna assembly 100 can include four second antennas. The four second antennas can be positioned such that each of the second antennas is positioned approximately orthogonal from one or more of the other second antennas. For example, according to some implementations, one or more of the second antennas is positioned 90-degrees from one or more of the other second antennas (e.g., 90-degrees, 180-degrees, 270-degrees). In this manner, the second antennas are positioned such that the radiation patterns are similar in polarization.

The third antenna 114 can include a GPS antenna. In some examples the third antenna can be positioned to optimize signal radiation from the third antenna. For example, the third antenna can be positioned to optimize GPS signal radiation. In this manner, the third antenna can be pointed towards the sky such that the signal of the third antenna propagates optimally for GPS purposes.

In some examples, the antenna assembly 100 can include at least one base. In some examples, the base can provide mechanical support to the antenna elements of the antenna assembly. For example, the antenna elements can be configured to affix to the base. The antenna elements can be affixed mechanically to the base with fasteners, solder, snaps, adhesive, and/or another form of fastening appropriate for the application disclosed herein. In some examples, the at least one base can be housed within the radome. The radome can include internal housing members for the base to be positioned in a mechanically secure manner. For example, the radome can be configured such that the housing of the radome can be mechanically lowered over the base, the first antenna, the second antenna, and the third antenna. In some examples, the base can be affixed to the radome. For example, the base can be affixed mechanically with screws, bolts, snaps, solder, adhesive, and/or any other manner of affixing the base appropriate for use as disclosed herein. The base can be configured to mechanically join with the first antenna, the second antenna, and/or the third antenna. For example, the base can include a circular shape such that the perimeter of the base can include one or more slots to mechanically join the antennas. In this manner, the base can be configured to support one or more of the first antenna 110, the second antenna 112, the third antenna 114, and the coaxial cables. The antenna system can include at least one base used to position the antennas. In some examples, the antenna elements of the antenna assembly 100 can be affixed in a circumferential manner around the base. In this manner, the antenna elements of the antenna assembly 100 can provide signal transmission reducing interference from a neighboring antenna element. For example, in an implementation where the antenna assembly 100 includes a plurality of first antennas, the first antennas can be affixed to the base such that each of the first antennas are approximately 90-degrees offset from one another. The first antennas can be offset any degree orientation from one another in some implementations. In a similar manner, in an implementation where the antenna assembly 100 includes a plurality of second antennas, the second antenna can be affixed to the base such that each of the second antennas are approximately 90-degrees offset from one another. The second antennas can be offset any degree orientation from one another in some implementations. In some examples, the first antennas and the second antennas can alternate positions.

In some examples, the radome can be configured to house two bases, a first base and a second base. The first base can be at a bottom side of the radome, configured to mechanically secure the first antenna and the second antenna. In this manner, the first base can be configured to mount one or more of the first antenna and the second antenna to stand vertically. According to some implementations, the second base can be at a top side of the radome, configured to mechanically secure one or more of the first antenna, the second antenna, and the third antenna. In this manner, the first base can be configured to mount the first antenna and the second antenna to stand vertically. In this manner, the third antenna can be positioned on a top side of at least a portion of a second base. In some examples, the radome can be configured to mechanically couple to the spacer 104. The spacer 104 can include one or more portions that is configured and adapted such that all of the antennas fit within or house the antennas to mechanically fit next to one another.

The antenna assembly can include a spacer 104, one or more screw holes 202, and one or more screws 204. In some examples, the spacer 104 can include the screw holes 202 and the screws 204. In some examples the screw holes 202 can be machined as part of the spacer 104. In some examples, the screws 204 can be configured to affix the spacer 104 to the radome (e.g., radome 102) via the screw holes 202. In some examples the spacer can include a shape with four elongated sides. In some examples, on each of the elongated sides, the spacer 104 can include two of the screw holes 202 and two of the screws 204. In some examples, the spacer 104 can be shaped to include any number of screw holes and screws to provide structural support to the antenna assembly 100. In some examples, the spacer 104 can be affixed to the radome with other types of fasteners. For example, the spacer 104 can be affixed to the radome with bolts, snaps, press fittings, adhesive, and/or another type of fastener suitable for the application disclosed herein.

In some examples, the spacer 104 can be configured to provide physical separation between a support (e.g., support assembly 106 from FIGS. 1A-1F) and the radome (e.g., radome 102 in FIGS. 1A-1F) and antenna elements (e.g., first antenna 110, second antenna 112, and third antenna 114 from FIGS. 1A-1F). The spacer can be manufactured from a material that does not interfere with the electromagnetic signals. In some examples, the spacer 104 can be made of a spacer material. The spacer material can include materials disclosed herein (e.g., materials for the radome from FIGS. 1A-1F). This spacer 104 can be manufactured in such a way that a top edge of the spacer 104 and a bottom edge of the spacer are each flush with the radome and the support, respectively. In some examples, the spacer 104 can be constructed through manufacturing, machining, and/or 3D printing.

In some examples, the spacer 104 can include mechanical support members within a body of the spacer 104. For example, in each of the elongated sides of the spacer 104, the mechanical support members can extend the length of the elongated side. In some examples, the spacer can include a cylindrical opening. For example, the spacer 104 can include the cylindrical opening at a center of the spacer 104. The spacer 104 can be configured to pass coaxial cables through the cylindrical opening. The spacer 104 can be affixed to the radome using the screws 204, or through mechanical members not illustrated (e.g., bolts, welding, adhesive, or mechanically pressed). The spacer 104 can be coupled to a support. In some examples, the spacer 104 can be manufactured as part of the radome or as part of the support.

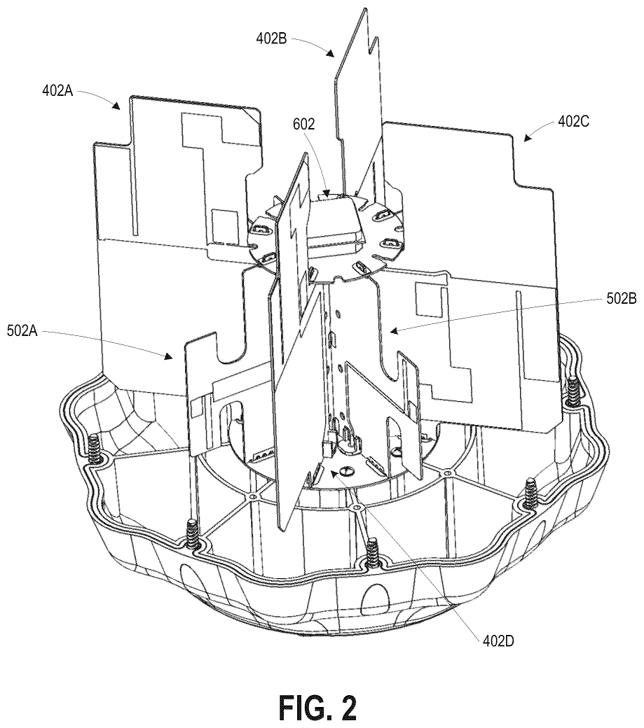

FIG. 2 illustrates a perspective view of an antenna assembly (such as, antenna assembly 100). The antenna assembly can include at least one of first antenna elements 402A-D. Each of the at least one of first antenna elements 402A-D can include a PCB base. The PCB base for each of the at least one of first antenna elements 402A-D can include one or more low-band radiating elements, one or more mid-band radiating elements, and/or one or more high-band radiating elements. In some examples, portions of the at least one of first antenna elements 402A-D are formed on a first/front side of the PCB base and some portions of the at least one of first antenna elements 402A-D are formed on a second/back side of the PCB base. In other implementations, the portions of the at least one of first antenna elements 402A-D could be formed on either the front side or the back side of the PCB base. In some examples, each of the at least one of first antenna elements 402A-D can include a first radiating section and a second radiating section. The first radiating section can include a first low-band radiating element, a first mid-band radiating element, and a first high-band radiating elements, and a microstrip transmission line. The second section can include a second low-band radiating element, a second mid-band radiating element, a second high-band radiating element, and/or a transmission line groundplane.

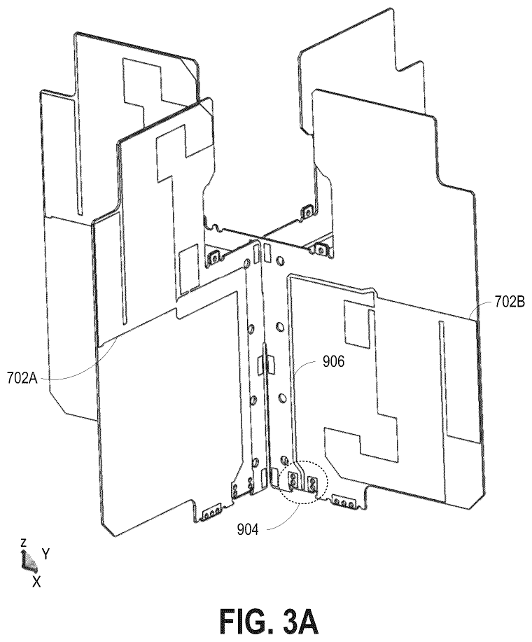

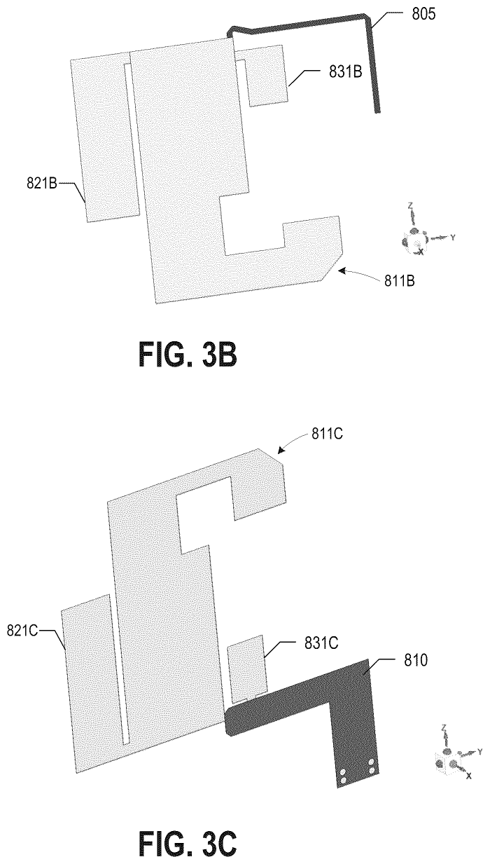

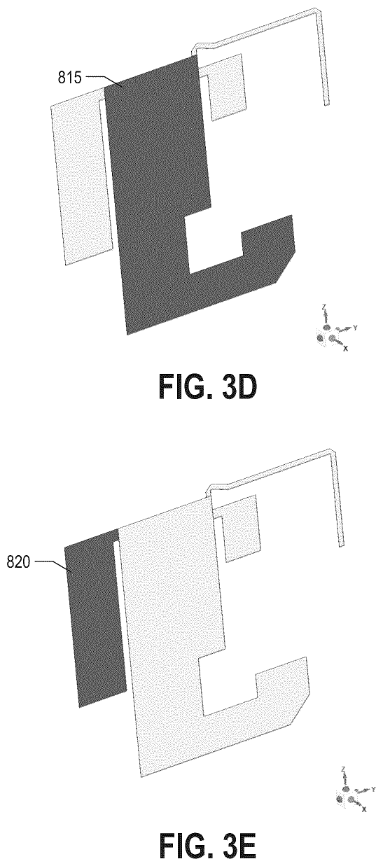

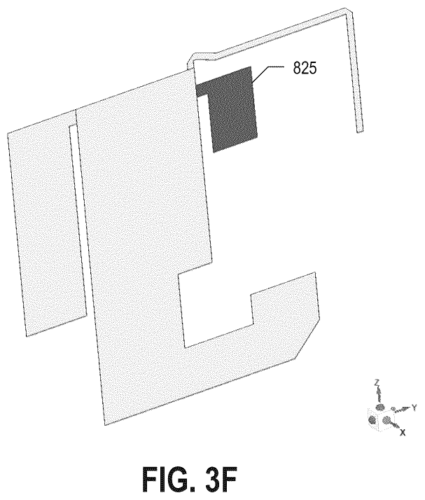

According to some embodiments, at least one of first antenna elements 402A-D can include a ground plane (also referred to herein as the “ground reference”). The ground plane can include a first ground plane on the front side of the PCB base and a second ground plane on the back side of the PCB base. The ground plane 810 can extend across one or more low-band radiating elements 811, one or more mid-band radiating elements 821, and/or one or more high-band radiating elements 831. The ground plane may serve as the ground reference for at least one or more low-band radiating elements, one or more mid-band radiating elements, and/or one or more high-band radiating elements. The ground plane can include a connection interface (shown in more detail in FIGS. 3B-3F). The connection interface can be configured to connect the one or more low-band radiating elements, one or more mid-band radiating elements, and one or more high-band radiating elements to a coaxial cable. For example, the coaxial cable can be mechanically and/or electrically coupled to the connection interface (e.g., using solder). Where the one or more low-band radiating elements, one or more mid-band radiating elements, and one or more high-band radiating elements are formed on one or both sides of the PCB base, the coaxial cable may be soldered to one or both sides of the PCB base. For example, the connection interface can be formed on both sides of the PCB base according to some implementations to 810 and 805. The ground planes may serve as a reference point for operation of the antenna assembly.

The antenna assembly can include at least one of second antenna elements 502A-D. Each of the at least one of second antenna elements 502A-D can include a PCB base. The PCB base for each of the at least one of second antenna elements 502A-D can include one or more dual-band radiating elements. In some examples, the dual-band radiating elements can include dual-band WiFi antennas. For example, the dual-band WiFi antennas can include dipole antennas. In some examples, portions of the at least one of second antenna elements 502A-D can be formed on a first/front side of the PCB base and some portions of the at least one of second antenna elements 502A-D are formed on a second/back side of the PCB base. In other implementations, the portions of the at least one of second antenna elements 502A-D could be formed on either the front side or the back side of the PCB base.

According to some embodiments, at least one of second antenna elements 502A-D can be used for un-licensed band wireless telecommunication purposes. In some examples, depending on the particular use, the number of dual-band WiFi radiator portions can vary. In some examples, the antenna assembly includes four dual-band WiFi radiator portions. However, more or less dual-band WiFi radiator portions are possible. In some cases, one or more of the dual-band WiFi radiator portions can be configured for Bluetooth communication. For example, one or more of the at least one of second antenna elements 502A-D can be a Bluetooth radiator portion. In some implementations, each of the at least one of second antenna elements 502A-D can be coupled to an individual coaxial cable.

The antenna assembly can include a third antenna element 602. The third antenna element 602 can include a PCB base. The PCB base for the third antenna element 602 can include one or more global positioning system (GPS) antenna elements. In some examples, portions of the third antenna element 602 are formed on a first/front side of the PCB base and some portions of the third antenna element 602 are formed on a second/back side of the PCB base. In other implementations, the portions of the third antenna element 602 could be formed on either the front side or the back side of the PCB base.

The third antenna element 602 can be used to collect one or more signal(s) from geosynchronous satellites so that the GPS function of a radio including the antenna assembly can determine where the antenna assembly is positioned relative to a global coordinate system. In some examples, depending on the particular use, the number of GPS antenna elements can vary. In some examples, the antenna assembly includes one GPS antenna elements. However, more or fewer GPS antenna elements are possible. The third antenna element 602 may be positioned on the first ground plane and within the radome (e.g., radome 102 from FIGS. 1A-1F). In this arrangement, the third antenna element 602 is supported by a base in the antenna assembly.

FIG. 3A illustrates a perspective view of one or more antenna elements. The one or more antenna elements can include a first antenna element 702A. The first antenna element 702 can include a number of radiating elements/arms/dipole arms. For example, the first antenna element 702 can include one or more high-band arms, one or more mid-band arms, and/or one or more low-band arms.

As noted herein, the first antenna element 702 can include a first radiating section and a second radiating section. Some features of the second radiating section are similar or identical to features of the first radiating section. The structure and description for the various features of the first radiating section and the operation are understood to apply to the corresponding features of the second radiating section, except as described differently below. The first radiating section can include a microstrip transmission line. The second radiating section can include a transmission line groundplane. In some examples, the first radiating section and the second radiating section can be coupled to form a single component. For example, the first antenna element can include the first radiating section and the second radiating section. In some examples, the first antenna element can include the first radiating section or the second radiating section. In some implementations, the second radiating section can be a mirror image of the first radiating section.

In some implementations, the first radiating section and the second radiating section may be formed primarily or entirely on the one side of the PCB base (e.g., the front side). However, having the radiating sections formed on both sides of the PCB base can provide certain benefits in some implementations. For example, this arrangement can reduce the complexity of the design. For example, the complexity of the baluns and microstrip lines can be reduced such that no crossing of lines occurs in the radiating sections. In another example, having the radiating sections on both sides of the PCB base can provide benefits of allowing the overall size of the antenna assembly to be reduced. For example, when the radiating sections are formed on one side of the PCB base, the size of the PCB base may need to be increased, which can cause the overall size of the antenna assembly to increase. Compact antennas are desirable, as such, an antenna assembly with a smaller volumetric profile can be desirable in some implementations. Additionally, having the radiating sections on both sides of the PCB base can reduce the complexity of the balun.

In some implementations, the microstrip lines can extend from one connection interface positioned on the ground plane at a position closer to the first radiating section than the second radiating section.

In some implementations, the first antenna element 702 can be adapted and configured for the C-Band, which can span approximately 4.0 GHz to 8.0 GHz. For example, when operating on a 5G cellular network, configuring the antenna assembly for the C-band can provide a balance between high data speeds and quality coverage. For example, in some cases, the C-band can provide advantages of being suitable for higher frequencies used for ultra-fast data transfer (e.g., millimeter-wave bands) and lower frequencies used for broader coverage (e.g., sub-6 GHz bands) in 5G networks. According to some implementations, references to C-band can span from approximately 3.4 GHz to approximately 4.2 GHz. According to some implementations, references to LAA can span from approximately 5 GHz to approximately 7 GHz.

FIGS. 3B-3F illustrate perspective views of a first antenna element (e.g., the first antenna element 702 in FIG. 3A). As illustrated in the FIGS. 3B-3F, non-highlighted portions are counter poses for portions of the first antenna element described herein. FIG. 3B illustrates a microstrip transmission line 805, a first antenna element 811B, a second antenna element 821B, and a third antenna element 831B. In some examples, the microstrip transmission line 805 can correspond with a first radiating element of the first antenna element (e.g., a first radiating element of the first antenna element 702 from FIG. 3A). The microstrip transmission line 805 can be configured to establish a connection from a coaxial connector to a radiating element. For example, the microstrip transmission line 805 can be configured to establish a connection from the coaxial cables to at least one of the one or more low-band antenna elements, one or more mid-band antenna elements, and/or one or more high-band antenna elements. In some examples, the microstrip transmission line 805 can correspond to a groundplane (e.g., the transmission line groundplane 810). In some examples, the microstrip transmission line 805 can include a mitered corner. The mitered corner can be configured to reduce reflection of an electromagnetic signal propagating across the microstrip transmission line 805. In some examples, the microstrip transmission line 805 can include an un-mitered bend, curved bend, or mitered bend. In some examples, the microstrip transmission line 805 can include at least one bend.

FIG. 3C illustrates a transmission line groundplane 810, a first antenna element 811C, a second antenna element 821C, and a third antenna element 831C. In some examples, the transmission line groundplane 810 can correspond with a second radiating element of the first antenna element (e.g., a second radiating element of the first antenna element 702 from FIG. 3A). The transmission line groundplane 810 can be configured to establish a connection from a coaxial connector to a radiating element. For example, the transmission line groundplane 810 can be configured to establish a connection from the coaxial cables to at least one of the one or more low-band antenna elements, one or more mid-band antenna elements, and/or one or more high-band antenna elements. The transmission line groundplane 810 can be configured to provide a groundplane for the microstrip transmission line 805. In this manner, the transmission line groundplane 810 can include a dielectric material of sufficient thickness to provide a groundplane for the applications disclosed herein. In some examples, the transmission line groundplane 810 can include non-defect groundplane or defected ground structures (DGS).

In FIG. 3D, a low-band antenna element 815 can include a low-band radiating element. The low-band arm can be configured for low band radiation (e.g., radiation less than approximately 1 GHz). The low-band arm can form a single dipole of the first antenna element 702 of FIG. 3A (e.g., the driven element and its counterpoise). In some examples, the low-band radiating element can be formed on the front side of the PCB base. According to some implementations, the low-band radiating element can be formed on the back side of the PCB base. The low-band radiating element can be coupled to a balun. The low-band radiating element can be L-shaped. For example, the low-band radiating element can include a first portion and a second portion where the second portion is perpendicular to the first portion (e.g., there can be an approximately 90-degree bend between the first portion and second portion). The balun can be coupled to the first portion. The first portion can extend in the negative Z-direction from the balun. The first portion and second portion can be rectangularly shaped. In other implementations, the first low-band radiating element can have a different shape.

From the center feed point, the low-band antenna element 815 can include a straight portion before the portions bend 90-degrees to form the first portion and the second portion. The low-band antenna element 815 can include a cutout section. In some examples, the cutout section can include a rectangular shape, a circular shape, a semi-circular shape, or another shape appropriate for the applications disclosed herein. The cutout section can be positioned at a location of the joining of the first portion and the second portion. The cutout section can be configured to allow for a discontinuity in a current flow at frequencies above a threshold. The cutout section can be configured to allow for the low-band antenna element 815 to produce a usable a radiation pattern shape at higher bands. The cutout section can be configured to match an impedance for the low-band antenna element 815.

In FIG. 3E, a mid-band antenna element 820 can include one or more mid-band radiating elements/arms/dipole arms. In some examples, the first antenna element 702 can include a mid-band radiating element (also referred to herein as the mid-band arm). The mid-band arm can be configured for mid band radiation (e.g., radiation approximately between 1700 MHz to 2700 MHZ). The mid-band arm can form a single dipole of the first antenna element 702 of FIG. 3A (e.g., the driven element and its counterpoise). The mid-band radiating element can be formed on either side of the PCB base. In some examples, the mid-band radiating element is formed on a first side (e.g., the front side) of the PCB base. In some examples, the mid-band radiating element can be formed on the back side of the PCB base. In this arrangement, the midband arm is transposed in orientation compared to the low-band arm. As noted herein, this arrangement can assist with the impedance matching and forming of the radiating pattern in the first antenna element 702. For example, on the first side of the PCB base, the low-band radiating element extends in the negative Z-direction and the mid-band radiating element extends in the negative Z-direction. The mid-band radiating element can be coupled to the balun. The mid-band radiating element can extend in the negative Z-direction from the balun. In some examples, the mid-band radiating element can be coupled to the microstrip line. The mid-band radiating element can extend in the positive Z-direction from the microstrip line. The mid-band radiating element can be rectangularly shaped. In other implementations, the mid-band radiating element can be shaped differently.

FIG. 3F illustrates a high-band antenna element 825. The corresponding counterpoise of antenna element 825 can be positioned on an opposite side of the PCB. The high-band antenna element 825 can include one or more high-band radiating elements/arms/dipole arms. In some examples, the first antenna element 702 can include a high-band radiating element (also referred to herein as the high-band arm). The high-band arm can be configured for high band radiation (e.g., radiation approximately above 2700 MHZ). The high-band arm can form a single dipole of the first antenna element 702 of FIG. 3A (e.g., the driven element and its counterpoise). The high-band radiating element can be formed on either side of the PCB base. In some examples, the high-band radiating element is formed on the front side of the PCB base. In some examples, the high-band radiating element can be formed on the back side of the PCB base. In this arrangement, the high-band arm can be transposed in orientation compared to the mid-band arm. For example, on the front side of the PCB base, the high-band radiating element extends in the negative Z-direction (e.g., in the same direction as the low-band radiating element) and the mid-band radiating element extends in the negative Z-direction. In some examples, the high-band radiating element can extend in the negative Z-direction (e.g., in the same direction as the low-band radiating element) and the mid-band radiating element extends in the positive Z-direction. The high-band radiating element can be coupled to the balun. The high-band radiating element can extend in the positive Z-direction from the balun. In some examples, the high-band radiating element can be coupled to the microstrip line. The high-band radiating element can extend in the negative Z-direction from the microstrip line. The high-band radiating element can be rectangle shaped. In other implementations, the high-band radiating element can have different shapes.

In some cases, the high-band arm can be the closest to the center of the first antenna element 702 and a connection interface. Moving in the positive Y-direction from the connection interface, the first antenna element 702 can be arranged such that the low-band arm is positioned furthest from the connection interface in the Y-direction and the high-band arm is the closest to the connection interface, with the mid-band arm between the high-band arm and the low-band arm in the Y-direction.

In some examples, the high-band antenna element 825 can be configured to generate a radiating portion predominantly used for the C-band frequencies. The C-band portion and its counter pose for the high band radiating portion can be connected to a groundplane for the microstrip feedline. The C-band portion can include a dipole. The dipole works in a usable manner when connected to the low band radiating portion. The dipole works better when the counter pose is connected to the groundplane of the microstrip transmission line. The C-band radiating portion can be on the opposite side of the low band radiation portion from the midband radiation portion. In this manner, the arrangement of the connection of the individual portions can be arranged to increase the desirability of the radiation patterns of the individual portions as well as reduce the diameter of the overall antenna.

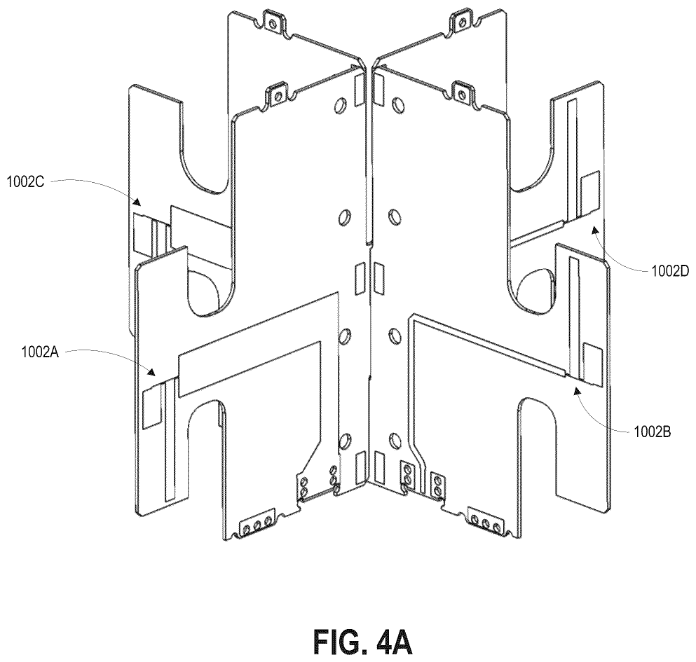

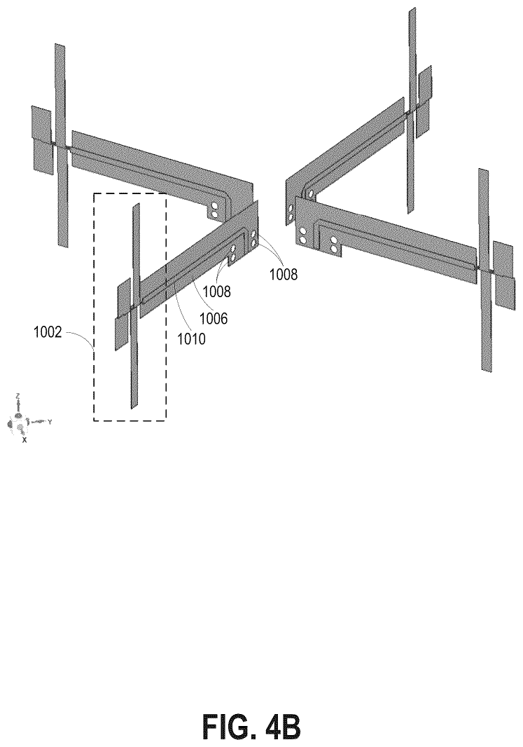

FIGS. 4A-4B illustrate perspective views of one or more antenna elements. The one or more antenna elements may include a dual band radiating element 1002A, transmission line groundplane 1006, connection points 1008, and a feed line 1010. In some examples, the dual band radiating element 1002 can be coupled to a base within a radome with the connection points 1008. The feed line 1010 can be coupled to the ground plane and a balun. The feed line 1010 can include a microstrip transmission line for the dual band radiating element 1002. In some implementations, the feed line 1010 can be on the back side of the PCB base. The center conductor of the coaxial cable can attach to the microstrip line 1010. In some examples, the feed line 1010 can include a mitered corner. The mitered corner can be configured to reduce reflection of an electromagnetic signal propagating across the feed line 1010. In some examples, the feed line 1010 can include an un-mitered bend, curved bend, or mitered bend. In some examples, the feed line 1010 can include at least one bend.

In some examples, the transmission line groundplane 1006 can be the ground plane for the microstrip transmission line. The ground plane and the microstrip line can form the microstrip transmission line for the dual band radiating element 1002. The microstrip transmission line extends from/is coupled to a connection interface. In this example, the balun can extend to the radiating elements on the front side of the PCB base and the microstrip transmission line extends to the radiating elements on the back side of the PCB base. The two distinct surfaces that form the microstrip transmission line and transmission line groundplane (e.g., microstrip line 805 and transmission line groundplane 810 in FIGS. 3B and 3C) can be used together to electrically excite radiating elements. The impedance of the feed point can vary, depending on the application of the antenna assembly. In one example, the feed point can have an impedance of 50-ohms. As explained herein, the radiating elements can have alternating polarity (e.g., alternating extension in the positive and negative Z-direction) to assist in the impedance matching and pattern construction of the first antenna element assembly. In other cases, the polarity of all the driven arms are in the same direction and the polarity of all the counterpoise arms are in the opposite direction as is the case for antenna elements 402 and 502.

The dual band radiating element 1002 can include a dual band dipole antenna. In some examples, the dual band radiating element 1002 can include four dual band dipole antennas. The four dual band dipole antennas can be configured to provide WiFi communications. The four dual band dipole antennas can be nested inside the footprint of the cellular antennas without impacting performance of the cellular antennas while maintaining useful radiation properties for the WiFi antennas.

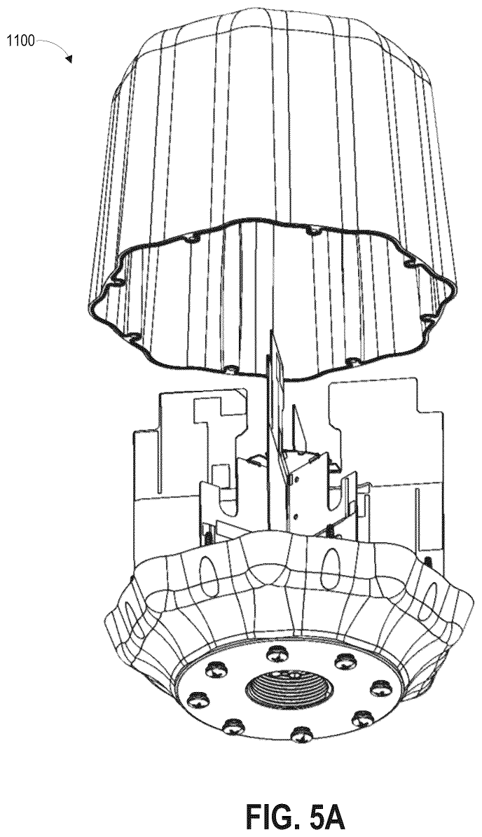

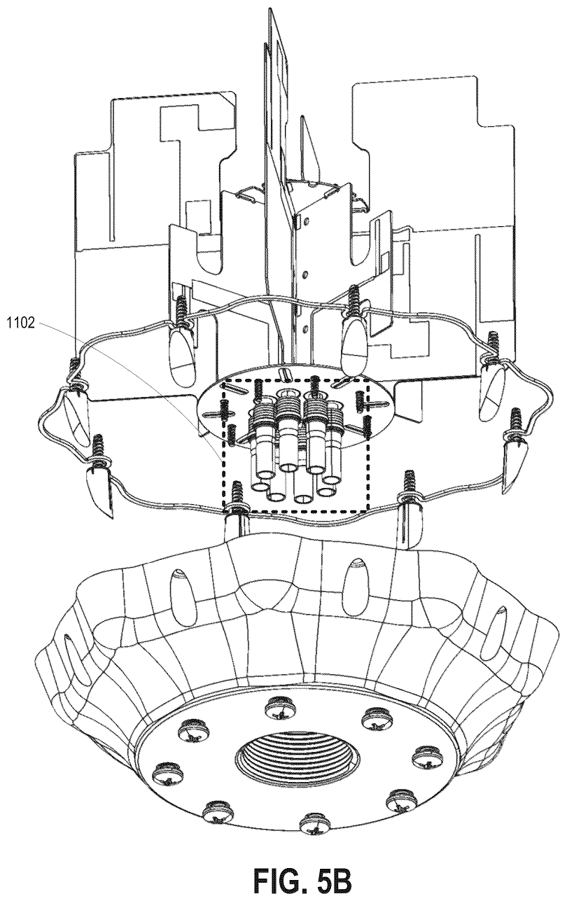

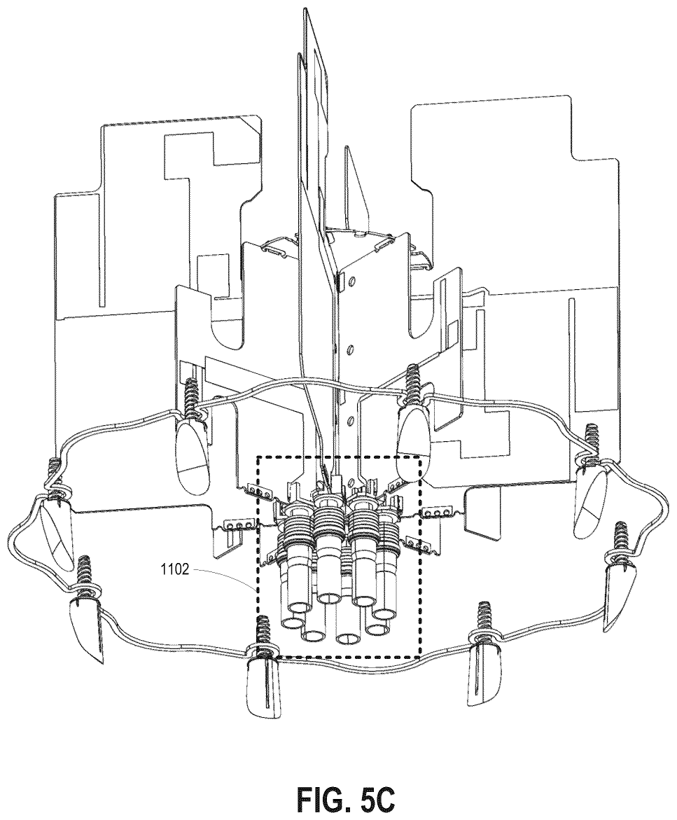

FIGS. 5A-5C illustrate perspective views of a coaxial cable assembly 1100. The coaxial cable assembly 1100 can include coaxial cables 1102. The coaxial cables 1102 are configured to pass along the antenna assembly. In some examples, the coaxial cables 1102 can be configured to pass within an internal component of the antenna assembly. In this manner, each of the coaxial cables 1102 can connect to a microstrip transmission line of each radiator. In some examples, at least some of the coaxial cables 1102 can be configured to pass along outside of the antenna assembly. In some examples, the coaxial cables 1102 can be configured to provide electromagnetic signals to the antenna elements by passing through components of the antenna assembly or independent from the components of the antenna assembly. For example, in a configuration where the antenna assembly lacks a spacer and is mounted directly to a building structure, the coaxial cables 1102 can be configured to pass through to the antenna elements from the building structure. In this manner, the coaxial cables 1102 are fed independent from a support and a spacer.

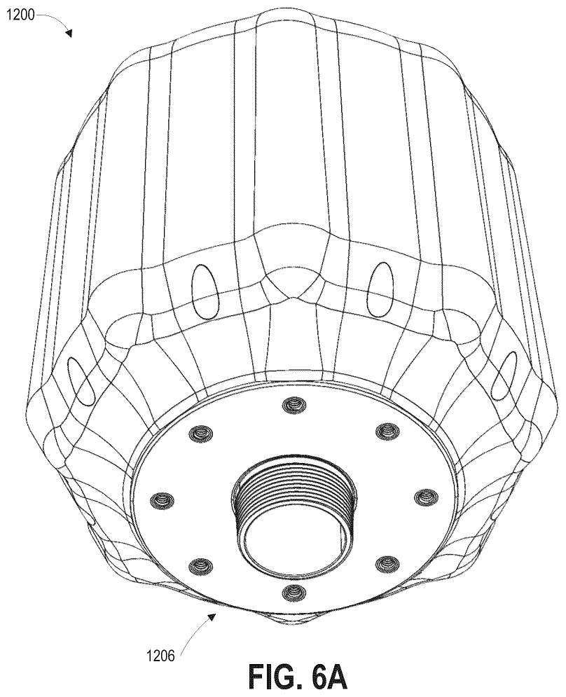

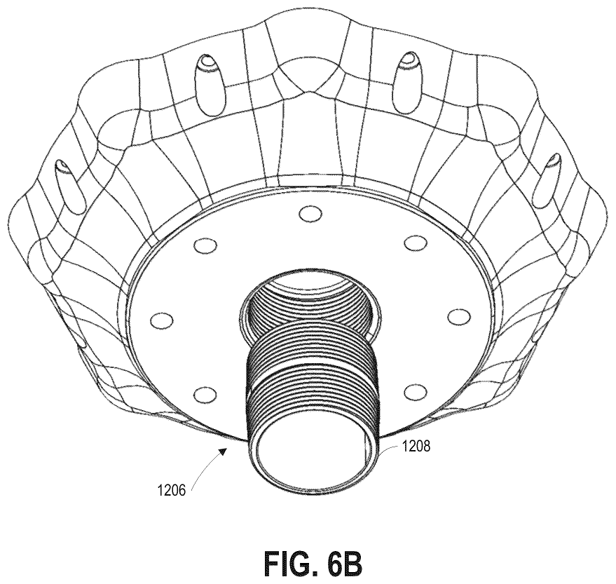

FIGS. 6A-6B illustrate perspective views of an antenna assembly 1200. The antenna assembly 1200 can include a support assembly 1206. The support assembly 1206 can include an assembly component 1208. The assembly component 1208 may be removable from the support assembly 1206. For example, the assembly component 1208 may include threads, such that the assembly component 1208 may affix to the support assembly 1206 (for example, screwing into the support assembly 1206). The threads of the assembly component 1208 may allow the antenna assembly 1200 to attach to a structure. For example, the structure may include a threaded cavity, to which the assembly component 1208 may affix.

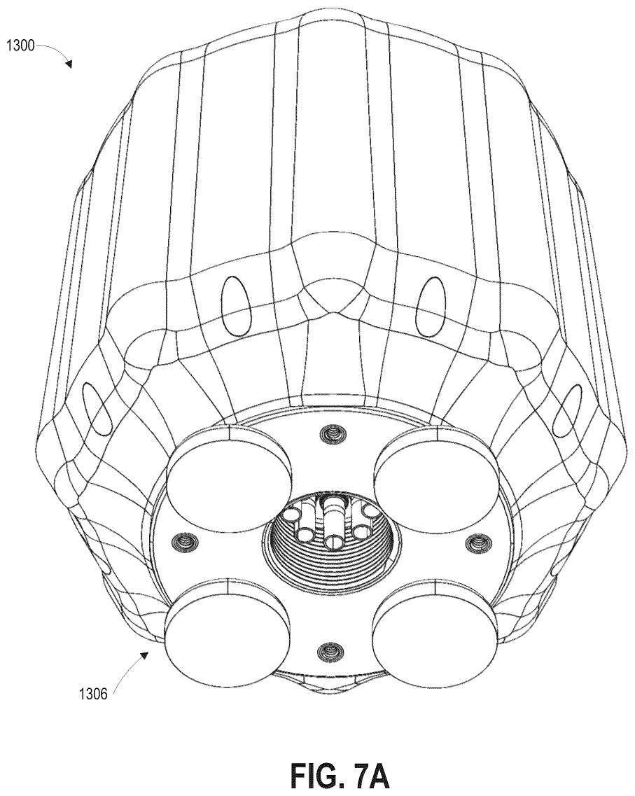

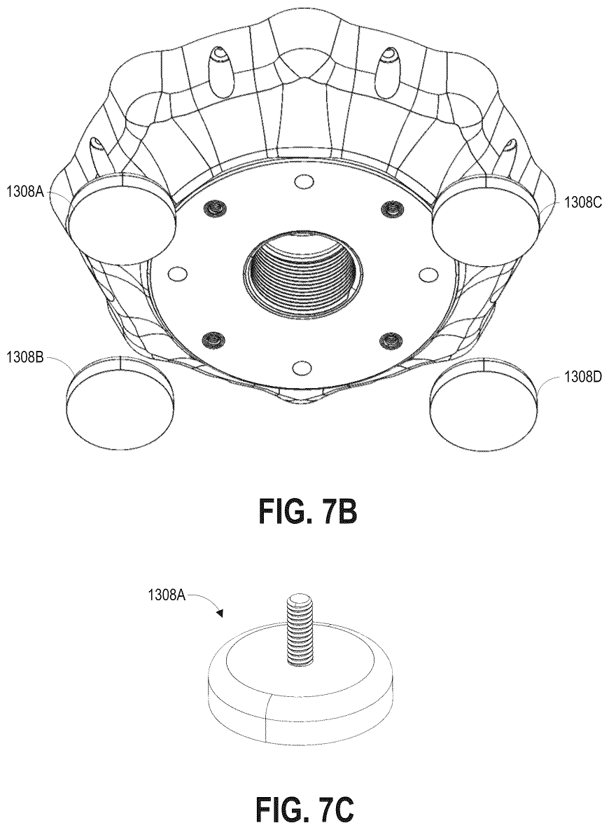

FIGS. 7A-7C illustrate perspectives view of an antenna assembly 1300. The antenna assembly 1300 can include a support assembly 1306. The support assembly 1306 can include one or more assembly components 1308A-D. The one or more assembly components 1308A-D may be removable from the support assembly 1306. For example, the one or more assembly components 1308A-D may include threads, such that the one or more assembly components 1308A-D may affix to the support assembly 1306 (for example, screwing into the support assembly 1306). The one or more assembly components 1308A-D may include magnets. For example, the antenna assembly 1300 may affix to a structure (such as, a metallic, magnetic structure) via the assembly components 1308A-D magnetically attaching to the structure.

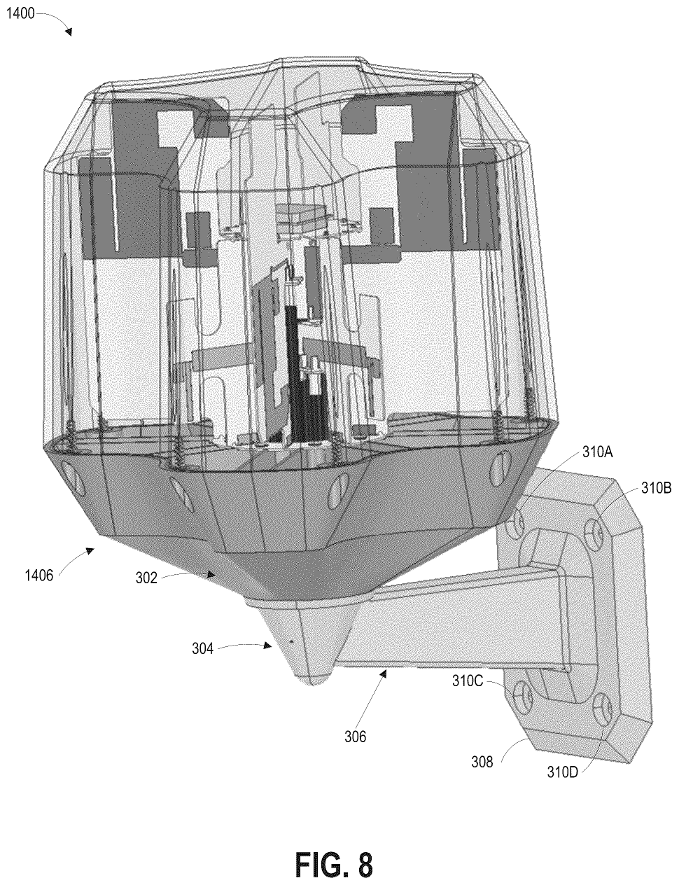

FIG. 8 illustrates a perspective view of an antenna assembly 1400. The antenna assembly 1400 can include a support assembly 1406. The support assembly 1406 can include a first support piece 302, a second support piece 304, a third support piece 306, and a fourth support piece 308. The fourth support piece 308 can include fastener holes 310A-D.

The first support piece 302 can be coupled to a radome and/or a spacer (e.g., radome 102 and spacer 104 of FIGS. 1A-1F, respectively). For example, the first support piece 302 can be mechanically affixed to the radome and the spacer. The first support piece 302 can be fastened to the radome and/or the spacer by a suitable connection applicable for the purposes described herein. In some examples, the spacer 104 can be affixed to the radome with other types of fasteners. For example, the first support piece 302 can be affixed to the spacer with bolts, snaps, press fittings, adhesive, and/or another type of fastener for the application disclosed herein. The first support piece 302 can be made of a material such as those described herein.

In some examples, the first support piece 302 can include a first side and a second side. The first side of the first support piece 302 can include a first plane orthogonal to a central axis and extending radially from the central axis. In some examples, the first plane can be circular. In some examples, the first plane can include four elongated members, with arcs connecting each of the elongated members such that the first plane resembles a plus sign with a hole in the center from a top view. The first support piece 302 can include a cylindrical member extending from a center of the first plane. For example, the cylindrical member can extend from the first plane of the first support piece 302 along the central axis. The cylindrical member can be configured to extend into the radome. The cylindrical member can include a hollow tube along the central axis. The first support piece 302 can include a hollow central member along the central axis. The cylindrical member at the center of the first support piece 302 can be configured to pass coaxial cables from the second support piece 304 to the radome (e.g., radome 102 in FIGS. 1A-1F).

In some examples, the second side can include a second plane orthogonal to the central axis and extending radially from the central axis. In some examples, the second plane can be circular with a circular hole in the center. Edges from the first side to the second side can be configured to taper from the first plane to the second plane. In some examples, the second side can be a distance away from the first side. The distance can be the length of the hollow tube.

This first support piece 302 can be manufactured in such a way that the top side of the first support piece 302 and the bottom side of the first support piece 302 each are flush with the spacer and the second support piece 304, respectively. In some examples, the first support piece 302 can be constructed through manufacturing, machining, and/or 3D printing. In some examples, the first support piece 302 can include a single component or a plurality of components affixed to form the first support piece 302.

The second support piece 304 can be coupled to the first support piece 302 and/or the third support piece 306. For example, the second support piece 304 can be affixed mechanically to the first support piece 302 and/or the third support piece 306. The second support piece 304 can be fastened to the first support piece 302 and/or the third support piece 306 by a suitable connection applicable for the purposes described herein. The second support piece 304 can be made of a material such as those described herein.

In some examples, the second support piece 304 can include a first side and a second side. The first side of the second support piece 304 can include a plane orthogonal to a central axis. In some examples, the plane can include circular shape. The second support piece 304 can include a hollow opening around the central axis and throughout the second support piece 304. The hollow opening of the second support piece 304 can be configured to pass coaxial cables from the third support piece 306 to the first support piece 302.

The second side of the second support piece 304 can include a shape extending from the plane. In this manner, the first side and the second side can be configured to join and form a cone shape with the plane as the base of the cone shape. In some examples, the hollow opening extends from the plane along the central axis to an opening on a surface of the cone shape. The opening on the surface of the cone shape is configured to pass the coaxial cables.

This second support piece 304 can be manufactured in such a way that the first side of the second support piece 304 and the second side of the second support piece 304 each can be flush with the first support piece 302 and the third support piece 306, respectively. In some examples, the second support piece 304 can be constructed through manufacturing, or machining, and/or 3D printing. In some examples, the second support piece 304 can include a single component or a plurality of components affixed to form the second support piece 304.

The third support piece 306 can be coupled to the second support piece 304 and/or the fourth support piece 308. For example, the third support piece 306 can be mechanically affixed to the second support piece 304 and the fourth support piece 308. The third support piece 306 can be fastened to the second support piece 304 and/or the fourth support piece 308 by a suitable connection applicable for the purposes described herein. The third support piece 306 can be made of a material such as those described herein.

In some examples, the third support piece 306 can include a first side and a second side. The first side of the third support piece 306 can include a plane along an axis of the second support piece 304. In some examples, the plane can include a rectangular shape. In some examples, the second side can include a second plane orthogonal to the lateral axis of the third support piece 306. In some examples, the second plane can include a rectangular shape. The third support piece 306 can include edges connecting the first side and the second side. The third support piece 306 can include a hollow opening around the axis and extending laterally throughout the third support piece 306. The hollow opening of the third support piece 306 can be configured to pass coaxial cables from the fourth support piece 308 to the second support piece 304.

This third support piece 306 can be manufactured in such a way that the first side of the third support piece 306 and the second side of the third support piece 306 each are flush with the second support piece 304 and the fourth support piece 308, respectively. In some examples, the third support piece 306 can be constructed through manufacturing, machining, and/or 3D printing. In some examples, the third support piece 306 can include a single component or a plurality of components affixed to form the third support piece 306.

The fourth support piece 308 can be coupled to a structure and/or to the third support piece 306. For example, the fourth support piece 308 can be mechanically affixed to the structure and/or the third support piece 306. The fourth support piece 308 can be fastened to the structure and/or the third support piece 306 by a suitable connection applicable for the purposes described herein. In some examples, the fourth support piece 308 can be affixed to the structure by passing fasteners using the fastener holes 310A-D. For example, the fourth support piece 308 can be affixed to the structure using bolts passed through the fastener holes 310A-D and securely coupled using nuts and washers. The fourth support piece 308 can be made of a material such as those described herein.

In some examples, the fourth support piece 308 can include a first side and a second side. The first side of the second support piece 304 can include a first plane orthogonal to a lateral axis. In some examples, the first plane can include a geometric shape (e.g., rectangular, octagonal, etc.). The second side of the fourth support piece 308 can include a second plane orthogonal to the lateral axis. In some examples, the second plane can include a geometric shape (e.g., rectangular, octagonal, etc.). The fourth support piece 308 can include a hollow opening around the lateral axis and throughout the fourth support piece 308. The hollow opening of the fourth support piece 308 can be configured to pass coaxial cables from the structure to the third support piece 306. In some examples, the hollow opening extends from the first plane along the lateral axis to the second plane.

This fourth support piece 308 can be manufactured in such a way that the first side of the fourth support piece 308 and the second side of the fourth support piece 308 each can be flush with the third support piece 306 and the structure, respectively. In some examples, the fourth support piece 308 can be constructed through manufacturing, machining, and/or 3D printing. In some examples, the fourth support piece 308 can include a single component or a plurality of components affixed to form the fourth support piece 308.

### Example Clauses

Various examples of systems relating to an antenna system are found in the following clauses:

Clause 1. An antenna assembly, comprising: a radome; a spacer coupled to the radome; a first antenna element formed on a first printed circuit board (PCB) and configured to be housed by the radome, wherein the first antenna element is a multi-band antenna element comprising: one or more low-band radiating elements; one or more mid-band radiating elements; and one or more high-band radiating elements; a second antenna element formed on a second PCB and configured to be housed by the radome, the second antenna element comprising one or more WiFi antenna elements; and a third antenna element formed on a third PCB and configured to be housed by the radome, the third antenna element comprising one or more global positioning system (GPS) antenna elements.

Clause 2. The antenna assembly of Clause 1, further comprising a lighting element configured to provide illumination to a surrounding area.

Clause 3. The antenna assembly of Clause 1, further comprising a solar panel coupled to the radome and configured to provide power to components of the antenna assembly.

Clause 4. The antenna assembly of Clause 1, further comprising a plurality of coaxial cables, wherein each of the coaxial cables is configured to provide an electromagnetic signal to one of the first antenna element, the second antenna element, or the third antenna element.

Clause 5. The antenna assembly of Clause 4, wherein the first antenna element comprises: a first radiating section, comprising: a first low-band radiating element; a first mid-band radiating element coupled to the first low-band radiating element; a first high-band radiating element coupled to the first low-band radiating element; and a microstrip transmission line coupled to one of the coaxial cables and at least one of the first low-band radiating element, the first mid-band radiating element, and the first high-band radiating element; and a second radiating section coupled to the first radiating section, wherein the second radiating section comprises: a second low-band radiating element; a second mid-band radiating element coupled to the second low-band radiating element; a second high-band radiating element coupled to the second low-band radiating element; and a transmission line groundplane coupled to one of the coaxial cables and at least one of the second low-band radiating element, the second mid-band radiating element, and the second high-band radiating element.

Clause 6. The antenna assembly of Clause 1, further comprising a support coupled to the spacer and configured to mount to an external structure.

Clause 7. The antenna assembly of Clause 6, further comprising a plurality of coaxial cables, wherein each of the coaxial cables is configured to provide an electromagnetic signal to one of the first antenna element, the second antenna element, or the third antenna element, wherein the support comprises an opening configured to guide the coaxial cables within the radome.

Clause 8. The antenna assembly of Clause 6, wherein the support comprises a type from at least one of a mounting arm for wall mounting, a mast mount for a ship, or a pole-mount support.

Clause 9. The antenna assembly of Clause 1, wherein the radome comprises a material from at least one of plastic, thermoplastic, polycarbonate, acrylonitrile butadiene styrene (ABS), polytetrafluoroethylene (PTFE), glass epoxy, high-performance polyaryletherketones, fluoropolymers, polyimide, polycarbonate (PC) and acrylonitrile butadiene styrene (ABS), and acrylonitrile styrene acrylate (ASA).

Clause 10. The antenna assembly of Clause 1, wherein the second antenna element comprises a dual-band WiFi antenna.

Clause 11. The antenna assembly of Clause 1, wherein the second antenna element comprises a dipole antenna.

Clause 12. The antenna assembly of Clause 1, wherein the one or more low-band radiating elements is L-shaped.

Clause 13. The antenna assembly of Clause 1, wherein the one or more mid-band radiating elements is rectangularly shaped.

Clause 14. The antenna assembly of Clause 1, wherein the multi-band antenna element comprises four multi-band antenna elements, wherein the first antenna element comprises four first antenna elements, wherein the multi-band antenna element and the first antenna element are coupled to a base and arranged along a circumference of the base including an alternating pattern, wherein the alternating pattern comprises alternating positions of the four multi-band antenna elements and the four first antenna elements.

Clause 15. A multi-band antenna element formed on a printed circuit board (PCB), the multi-band antenna element comprising: one or more low-band radiating elements; one or more mid-band radiating elements; and one or more high-band radiating elements, wherein the one or more low-band radiating elements comprises a cutout section, wherein the cutout section is configured to provide a discontinuity in a current flow at frequencies above a threshold.

Clause 16. The multi-band antenna element of Clause 15, wherein the one or more low-band radiating elements comprises a first low-band arm and a second low-band arm, wherein the one or more mid-band radiating elements comprises a mid-band arm, wherein the one or more high-band radiating elements comprises a high-band arm.

Clause 17. The multi-band antenna element of Clause 16, wherein the first low-band arm, the second low-band arm, the mid-band arm, and the high-band arm are formed on a first side of the PCB.

Clause 18. The multi-band antenna element of Clause 16, wherein the first low-band arm and the second low-band arm are L-shaped.

Clause 19. The multi-band antenna element of Clause 18, wherein the cutout section comprises a cutout positioned in a 90-degree bend of the L-shape.

Clause 20. The multi-band antenna element of Clause 19, wherein the cutout is semi-circular shaped.

Clause 21. The multi-band antenna element of Clause 16, wherein the mid-band arm is rectangularly shaped.

Clause 22. The multi-band antenna element of Clause 16, wherein the high-band arm is rectangularly shaped.

Clause 23. The multi-band antenna element of Clause 17, wherein the first low-band arm and the high-band arm extend in a first direction and the mid-band arm extends in a second direction, the second direction opposite the first direction.

Clause 24. The multi-band antenna element of Clause 23, wherein the second low-band arm and the high-band arm extend in the second direction and the mid-band arm extends in the first direction.

Clause 25. An antenna assembly comprising: a radome; a spacer configured to be coupled to the radome; a base housed within the radome, wherein the base is circular in shape; a first antenna element formed on a first printed circuit board (PCB) and configured to be housed by the radome, wherein the first antenna element is a multi-band antenna element comprising: one or more low-band radiating elements; one or more mid-band radiating elements; and one or more high-band radiating elements; a second antenna element formed on a second PCB and configured to be housed by the radome, the second antenna element comprising one or more WiFi antenna elements; and a third antenna element formed on a third PCB and configured to be housed by the radome, the third antenna element comprising one or more global positioning system (GPS) antenna elements, wherein the first antenna element and the second antenna element are coupled to the base and arranged along a circumference of the base.

Clause 26. The antenna assembly of Clause 25, further comprising a lighting element configured to provide illumination to a surrounding area.

Clause 27. The antenna assembly of Clause 25, further comprising a solar panel coupled to the radome and configured to provide power to components of the antenna assembly.

Clause 28. The antenna assembly of Clause 25, further comprising a plurality of coaxial cables, wherein each of the coaxial cables is configured to provide an electromagnetic signal to one of the first antenna element, the first antenna element, or the second antenna element.

Clause 29. The antenna assembly of Clause 28, wherein the multi-band antenna element comprises: a first radiating section, comprising: a first low-band radiating element; a first mid-band radiating element coupled to the first low-band radiating element; a first high-band radiating element coupled to the first low-band radiating element; and a microstrip transmission line coupled to one of the coaxial cables and at least one of the first low-band radiating element, the first mid-band radiating element, and the first high-band radiating element; and a second radiating section coupled to the first radiating section, wherein the second radiating section comprises: a second low-band radiating element; a second mid-band radiating element coupled to the second low-band radiating element; a second high-band radiating element coupled to the second low-band radiating element; and a transmission line groundplane coupled to one of the coaxial cables and at least one of the second low-band radiating element, the second mid-band radiating element, and the second high-band radiating element.

Clause 30. The antenna assembly of Clause 25, further comprising a support coupled to the spacer and configured to mount to an external structure.

Clause 31. The antenna assembly of Clause 30, further comprising a plurality of coaxial cables, wherein each of the coaxial cables is configured to provide an electromagnetic signal to one of the first antenna element, the second antenna element, or the third antenna element, wherein the support comprises an opening configured to guide the coaxial cables within the radome.

Clause 32. The antenna assembly of Clause 30, wherein the support comprises a type from at least one of a mounting arm for wall mounting, a mast mount for a ship, or a pole-mount support.

Clause 33. The antenna assembly of Clause 25, wherein the radome comprises a material from at least one of plastic, thermoplastic, polycarbonate, acrylonitrile butadiene styrene (ABS), polytetrafluoroethylene (PTFE), glass epoxy, high-performance polyaryletherketones, fluoropolymers, polyimide, polycarbonate (PC) and acrylonitrile butadiene styrene (ABS), and acrylonitrile styrene acrylate (ASA).

Clause 34. The antenna assembly of Clause 25, wherein the second antenna element comprises a dual-band WiFi antenna.

Clause 35. The antenna assembly of Clause 25, wherein the second antenna element comprises a dipole antenna.

Clause 36. The antenna assembly of Clause 25, wherein the one or more low-band radiating elements is L-shaped.

Clause 37. The antenna assembly of Clause 25, wherein the one or more mid-band radiating elements is rectangularly shaped.

Clause 38. The antenna assembly of Clause 25, comprising four multi-band antenna elements and four first antenna elements, wherein the four multi-band antenna elements and the four first antenna elements are coupled to the base and arranged along the circumference of the base including an alternating pattern, wherein the alternating pattern comprises alternating positions of the four multi-band antenna elements and the four first antenna elements.

Clause 39. The antenna assembly of Clause 25, wherein the base comprises a first base component and a second base component.

Clause 40. An antenna assembly, comprising: a radome; a spacer coupled to the radome; four first antenna elements, each formed on a separate first printed circuit board (PCB) and each configured to be housed by the radome, wherein each of the four first antenna elements are multi-band antenna elements, each of the four first antenna elements comprising: one or more low-band radiating elements, configured for low band radiation; one or more mid-band radiating elements, configured for mid band radiation; and one or more high-band radiating elements, configured for high band radiation; four second antenna elements, each formed on a separate second PCB and each configured to be housed by the radome, the four second antenna elements each comprising one or more WiFi antenna elements; a third antenna element formed on a third PCB and configured to be housed by the radome, the third antenna element comprising one or more global positioning system (GPS) antenna elements; and a base, coupled to the four first antenna elements and the four second antenna elements, wherein the four first antenna elements and the four second antenna elements are arranged along a circumference of the base in an alternating pattern, wherein the alternating pattern comprises alternating positions of the four second antenna elements and the four first antenna elements.

Clause 41. The antenna assembly of Clause 40, further comprising a lighting element configured to provide illumination to a surrounding area.

Clause 42. The antenna assembly of Clause 40, further comprising a solar panel coupled to the radome and configured to provide power to components of the antenna assembly.

Clause 43. The antenna assembly of Clause 40, further comprising a plurality of coaxial cables, wherein each of the coaxial cables is configured to provide an electromagnetic signal to one of the four first antenna elements, the four second antenna elements, or the third antenna element.

Clause 44. The antenna assembly of Clause 43, wherein each first antenna element of the four first antenna elements comprises: a first radiating section, comprising: a first low-band radiating element; a first mid-band radiating element coupled to the first low-band radiating element; a first high-band radiating element coupled to the first low-band radiating element; and a microstrip transmission line coupled to one of the coaxial cables and at least one of the first low-band radiating element, the first mid-band radiating element, and the first high-band radiating element; and a second radiating section coupled to the first radiating section, wherein the second radiating section comprises: a second low-band radiating element; a second mid-band radiating element coupled to the second low-band radiating element; a second high-band radiating element coupled to the second low-band radiating element; and a transmission line groundplane coupled to one of the coaxial cables and at least one of the second low-band radiating element, the second mid-band radiating element, and the second high-band radiating element.

Clause 45. The antenna assembly of Clause 40, further comprising a support coupled to the spacer and configured to mount to an external structure.

Clause 46. The antenna assembly of Clause 45, further comprising a plurality of coaxial cables, wherein each of the coaxial cables is configured to provide an electromagnetic signal to one of the four first antenna elements, the four second antenna elements, or the third antenna element, wherein the support comprises an opening configured to guide the coaxial cables within the radome.

Clause 47. The antenna assembly of Clause 45, wherein the support comprises a type from at least one of a mounting arm for wall mounting, a mast mount for a ship, or a pole-mount support.

Clause 48. The antenna assembly of Clause 40, wherein the radome comprises a material from at least one of plastic, thermoplastic, polycarbonate, acrylonitrile butadiene styrene (ABS), polytetrafluoroethylene (PTFE), glass epoxy, high-performance polyaryletherketones, fluoropolymers, polyimide, polycarbonate (PC) and acrylonitrile butadiene styrene (ABS), and acrylonitrile styrene acrylate (ASA).

Clause 49. The antenna assembly of Clause 40, wherein each of the second antenna elements comprise a dual-band WiFi antenna.

Clause 50. The antenna assembly of Clause 40, wherein each of the second antenna elements comprise a dipole antenna.

Clause 51. The antenna assembly of Clause 40, wherein the one or more low-band radiating elements is L-shaped.

Clause 52. The antenna assembly of Clause 40, wherein the one or more mid-band radiating elements is rectangularly shaped.

Clause 53. The antenna assembly of Clauses 1-52 wherein the support comprises a support assembly and an assembly component, wherein the support assembly comprises a threaded cavity configured to receive threading of the assembly component to affix the assembly component to the support assembly.

Clause 54. The antenna assembly of Clauses 1-52, wherein the support comprises a support assembly and a plurality of assembly components, wherein the plurality of assembly components each comprise a magnetic component configured to magnetically affix the antenna assembly to a structure.

### Additional Considerations and Terminology

Features, materials, characteristics, or groups described in conjunction with a particular aspect, implementation, or example are to be understood to be applicable to any other aspect, implementation or example described herein unless incompatible therewith. All of the features disclosed in this specification (including any accompanying claims, abstract and drawings), or all of the steps of any method or process so disclosed, may be combined in any combination, except combinations where at least some of such features or steps are mutually exclusive. The protection is not restricted to the details of any foregoing implementations. The protection extends to any novel one, or any novel combination, of the features disclosed in this specification (including any accompanying claims, abstract and drawings), or to any novel one, or any novel combination, of the steps of any method or process so disclosed.

While certain implementations have been described, these implementations have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. Those skilled in the art will appreciate that in some implementations, the actual steps taken in the processes illustrated or disclosed may differ from those shown in the figures. Depending on the implementation, certain of the steps described above may be removed, others may be added. For example, the actual steps or order of steps taken in the disclosed processes may differ from those shown in the figure. Depending on the implementation, certain of the steps described above may be removed, others may be added. Furthermore, the features and attributes of the specific implementations disclosed above may be combined in different ways to form additional implementations, all of which fall within the scope of the present disclosure.

Although the present disclosure includes certain implementations, examples and applications, it will be understood by those skilled in the art that the present disclosure extends beyond the specifically disclosed implementations to other alternative implementations or uses and obvious modifications and equivalents thereof, including implementations which do not provide all of the features and advantages set forth herein. Accordingly, the scope of the present disclosure is not intended to be limited by the described implementations, and may be defined by claims as presented herein or as presented in the future.

Conditional language, such as “can,” “could,” “might,” or “may,” unless specifically stated otherwise, or otherwise understood within the context as used, is generally intended to convey that certain implementations include, while other implementations do not include, certain features, elements, or steps. Thus, such conditional language is not generally intended to imply that features, elements, or steps are in any way required for one or more implementations or that one or more implementations necessarily include logic for deciding, with or without user input or prompting, whether these features, elements, or steps are included or are to be performed in any particular implementation. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Likewise the term “and/or” in reference to a list of two or more items, covers all of the following interpretations of the word: any one of the items in the list, all of the items in the list, and any combination of the items in the list. Further, the term “each,” as used herein, in addition to having its ordinary meaning, can mean any subset of a set of elements to which the term “each” is applied. Additionally, the words “herein,” “above,” “below,” and words of similar import, when used in this application, refer to this application as a whole and not to any particular portions of this application.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain implementations require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain implementations, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

What is claimed is:

1. An antenna assembly, comprising:
a radome;
a spacer coupled to the radome;
a first antenna element formed on a first printed circuit board (PCB) and configured to be housed by the radome, wherein the first antenna element is a multi-band antenna element comprising:
one or more low-band radiating elements;
one or more mid-band radiating elements; and
one or more high-band radiating elements;
a second antenna element formed on a second PCB and configured to be housed by the radome, the second antenna element comprising one or more WiFi antenna elements; and
a third antenna element formed on a third PCB and configured to be housed by the radome, the third antenna element comprising one or more global positioning system (GPS) antenna elements.

2. The antenna assembly of claim 1, further comprising a lighting element configured to provide illumination to a surrounding area.

3. The antenna assembly of claim 1, further comprising a solar panel coupled to the radome and configured to provide power to components of the antenna assembly.

4. The antenna assembly of claim 1, further comprising a plurality of coaxial cables, wherein each of the coaxial cables is configured to provide an electromagnetic signal to one of the first antenna element, the second antenna element, or the third antenna element.

5. The antenna assembly of claim 4, wherein the first antenna element comprises:
a first radiating section, comprising:
a first low-band radiating element;
a first mid-band radiating element coupled to the first low-band radiating element;
a first high-band radiating element coupled to the first low-band radiating element; and
a microstrip transmission line coupled to one of the coaxial cables and at least one of the first low-band radiating element, the first mid-band radiating element, and the first high-band radiating element; and
a second radiating section coupled to the first radiating section, wherein the second radiating section comprises:
a second low-band radiating element;
a second mid-band radiating element coupled to the second low-band radiating element;
a second high-band radiating element coupled to the second low-band radiating element; and
a transmission line groundplane coupled to one of the coaxial cables and at least one of the second low-band radiating element, the second mid-band radiating element, and the second high-band radiating element.

6. The antenna assembly of claim 1, further comprising a support coupled to the spacer and configured to mount to an external structure.

7. The antenna assembly of claim 6, further comprising a plurality of coaxial cables, wherein each of the coaxial cables is configured to provide an electromagnetic signal to one of the first antenna element, the second antenna element, or the third antenna element, wherein the support comprises an opening configured to guide the coaxial cables within the radome.

8. The antenna assembly of claim 6, wherein the support comprises a type from at least one of a mounting arm for wall mounting, a mast mount for a ship, or a pole-mount support.

9. The antenna assembly of claim 1, wherein the radome comprises a material from at least one of plastic, thermoplastic, polycarbonate, acrylonitrile butadiene styrene (ABS), polytetrafluoroethylene (PTFE), glass epoxy, high-performance polyaryletherketones, fluoropolymers, polyimide, polycarbonate (PC) and acrylonitrile butadiene styrene (ABS), and acrylonitrile styrene acrylate (ASA).

10. The antenna assembly of claim 1, wherein the second antenna element comprises a dual-band WiFi antenna.

11. The antenna assembly of claim 1, wherein the second antenna element comprises a dipole antenna.

12. The antenna assembly of claim 1, wherein the one or more low-band radiating elements is L-shaped.

13. The antenna assembly of claim 1, wherein the one or more mid-band radiating elements is rectangularly shaped.

14. The antenna assembly of claim 1, wherein the multi-band antenna element comprises four multi-band antenna elements, wherein the first antenna element comprises four first antenna elements, wherein the multi-band antenna element and the first antenna element are coupled to a base and arranged along a circumference of the base including an alternating pattern, wherein the alternating pattern comprises alternating positions of the four multi-band antenna elements and the four first antenna elements.

15. A multi-band antenna element formed on a printed circuit board (PCB), the multi-band antenna element comprising:
one or more low-band radiating elements;
one or more mid-band radiating elements; and
one or more high-band radiating elements,
wherein the one or more low-band radiating elements comprises a cutout section, wherein the cutout section is configured to provide a discontinuity in a current flow at frequencies above a threshold.

16. The multi-band antenna element of claim 15, wherein the one or more low-band radiating elements comprises a first low-band arm and a second low-band arm, wherein the one or more mid-band radiating elements comprises a mid-band arm, wherein the one or more high-band radiating elements comprises a high-band arm.

17. The multi-band antenna element of claim 16, wherein the first low-band arm, the second low-band arm, the mid-band arm, and the high-band arm are formed on a first side of the PCB.

18. The multi-band antenna element of claim 16, wherein the first low-band arm and the second low-band arm are L-shaped.

19. The multi-band antenna element of claim 18, wherein the cutout section comprises a cutout positioned in a 90-degree bend of the L-shape.

20. The multi-band antenna element of claim 19, wherein the cutout is semi-circular shaped.

21. The multi-band antenna element of claim 16, wherein the mid-band arm is rectangularly shaped.

22. The multi-band antenna element of claim 16, wherein the high-band arm is rectangularly shaped.

23. The multi-band antenna element of claim 17, wherein the first low-band arm and the high-band arm extend in a first direction and the mid-band arm extends in a second direction, the second direction opposite the first direction.

24. The multi-band antenna element of claim 23, wherein the second low-band arm and the high-band arm extend in the second direction and the mid-band arm extends in the first direction.
